(19) United States
(12) Patent Application Publication
(10) Pub. No.: US 2011/0255287 A1
(43) Pub. Date: Oct. 20, 2011

(54) CONNECTORS FOR LED STRIP LIGHTING

(76) Inventor: Qing (Charles) Li, Blacksburg, VA (US)

(21) Appl. No.: 13/106,558

(22) Filed: May 12, 2011

Related U.S. Application Data
(63) Continuation-in-part of application No. 12/975,112, filed on Dec. 21, 2010.
Application No. 12/975,112 is a continuation-in-part of application No. 12/499,306, filed on Jul. 8, 2009.
(60) Provisional application No. 61/333,806, filed on May 12, 2010.
(60) Provisional application No. 61/288,815, filed on Dec. 21, 2009.
(60) Provisional application No. 61/079,042, filed on Jul. 8, 2008.

(51) Int. Cl. F21S 4/00; H01R 12/71

(52) U.S. Cl. 362/249.02; 439/56; 362/249.01

(57) ABSTRACT

The present invention is directed to connectors for lighting strips. More particularly, the present invention relates to modular lighting systems, which provide for physical and electrical interconnection of multiple lighting strip devices to form lighting systems. In an embodiment, the present invention provides a connector assembly for modular lighting strips comprising: two or more integrally-formed plugs or sockets joined together in a manner to provide for physical and electrical connection with two or more lighting strips comprising a non-conductive substrate strip with an electrical circuit; a plurality of light sources operably connected to the electrical circuit; and a plug or socket integrally formed at opposing ends of the substrate strip; wherein the plugs and sockets provide for removable, friction-fit, and electrical interconnection of two or more circuits of the lighting strips.

### CROSS-REFERENCE TO RELATED APPLICATIONS

This application claims priority to and the benefit of the filing date of U.S. Provisional Patent Application No. 61/333,806, filed on May 12, 2010; and this application is a Continuation-in-Part of U.S. application Ser. No. 12/975,112, filed on Dec. 21, 2010, which claims priority to and the benefit of the filing date of U.S. Application Ser. No. 61/288,815, filed on Dec. 21, 2009, which CIP is a Continuation-in-Part of U.S. application Ser. No. 12/499,306, filed on Jul. 8, 2009, which claims priority to and the benefit of the filing date of U.S. Application Ser. No. 61/079,042, filed on Jul. 8, 2008, the disclosures of each of which are hereby incorporated by reference herein in their entireties.

### BACKGROUND OF THE INVENTION

1. Field of the Invention

The present invention relates to connectors for lighting strips, and more particularly for modular lighting systems, which provide for physical and electrical interconnection of multiple lighting strip devices to form lighting systems.

2. Description of Related Art

Lighting strips and illumination systems such as signs, displays, and other lighting systems have been used for many years. Such signs and displays typically have extended life spans, can be formed to a variety of different shapes and are operative at a relatively low cost. Although lighting systems have been somewhat successful, the known lighting systems have encountered certain problems. One known problem is the excessive number of components required to make such lighting systems. Another problem relates to the fragile nature of such lighting systems. Often lighting systems must be individually crafted which increases the purchasing price associated with such lighting systems. Another problem with known lighting systems relates to the lack of convenient interconnectable components of individual lighting sections and the lack of easily removable and securely fit interconnections.

Thus, there remains a need for an improved lighting system and improved connectors which are capable of being interconnected with a variety of lighting strips having a variety of shapes and configurations. In particular, there remains a need for an improved lighting system having light strip sections easily assembled and securely fit interconnections that can be easily removed and interchanged with a number of light strip sections having varying overall shapes.

### SUMMARY OF THE INVENTION

Embodiments of the present invention provide connectors for flexible or rigid strip lighting devices that can be combined and conveniently interconnected with the strip lighting to form modular lighting systems. The connectors can be used with waterproof, water-resistant, or non-waterproof lighting strips.

Connectors of the invention include junctions (plugs and/or sockets) for joining together, electrically and mechanically, one or more lighting strips into a lighting strip system. The connectors can be operably configured to provide 1-way, 2-way, 3-way, 4-way, 5-way, 6-way, 7-way, 8-way (and so on) connection of the lighting strips. A “double” connector, for example, can be operably configured to provide for electrical and physical connection at two junctions, which can be both plug- or socket-type, or one each of a plug-type and a socket-type junction. Another embodiment can comprise a “cross” type connector, which can provide a 4-way intersection of lighting strips. A Y-type connector can provide a 3-way intersection of lighting strips, and so on. The shape of the connector is not critical to the functionality that the connector is capable of providing. For example, a Y-type connector can be Y-shaped and only provide for a 2-way connection, if desired.

Connectors of the invention can comprise two identical sockets joined together at their electrical contacts to form a double connector. In this manner, the same components that are used for the lighting strip sockets can also be used for the connectors thus achieving simplicity in manufacturing, as no special socket components are required. For 3-way and 4-way type sockets, three or four, respectively, identical sockets can be incorporated with a PCB and circuit to for the complex connector. Again, by using standard socket components, a manufacturer can easily make the connectors from existing parts instead of creating another part that cannot be used with other components, such as the lighting strips or connections with a power source through wire leads.

The connectors can comprise any number of plugs and/or sockets, depending mostly on the requirements of a particular desired application for which the connectors are to be used. One embodiment includes a cross-type connector (X-type), operably configured to allow for power to flow through the electrical circuit of the lighting system by having one input and three outputs (i.e., 4-way). Using such a connector, the current traveling through a single lighting strip can enter the connector at one junction and exit the connector at three junctions into three separate lighting strips. Likewise, a 4-way connector can be configured to allow for the flow of current through the connector in a manner which provides two inputs and two outputs through the connector. The number of sockets and/or plugs and/or junctions is not critical, nor is it critical in which direction (in or out) the current flows through the connector within any particular lighting system and all such combinations are possible.

In preferred embodiments, the configuration, including size, shape, and electrical pathway, of the plug of the lighting strips are the same as the plug of the connector and the socket of the lighting strips are the same as the socket of the connector. The connector can be a segment of lighting strip with no LEDs and which is typically shorter in length. The connectors share features of the lighting strips in that the connectors comprise a non-conductive substrate, an electrical pathway (circuit), and plugs and/or sockets for completing the circuit between two or more lighting strips.

Included in embodiments of the invention are modular lighting systems with 1) one or more lighting strips comprising: a non-conductive substrate strip comprising an electrical circuit; a plurality of light sources operably connected to the electrical circuit; a plug or socket integrally formed at opposing ends of the substrate strip; and 2) one or more connectors having one or more plugs or sockets, each operably configured to provide for physical and electrical connection with one or more of the lighting strips. The non-conductive substrates are preferably elongated strips that can be cut to any desired length and the light sources on the strip remain operable after cutting.

Preferred embodiments include configurations wherein the plugs and sockets of the lighting strips and connectors provide for removable, friction-fit, latchless, and electrical interconnection of two or more circuits. The connectors can also be joined in a non-removable manner, i.e., with adhesive or other mechanical connection that might render the connector or lighting strip unusable one detached from the system, but modular or reusable strips and connectors and most preferred. Other means for securing the lighting strips and connectors together in a lighting system can include overlaying the electrical contacts of the components to be joined and securing them to ensure an electrical connection between the two. Latches can also be used, but are less preferred.

Embodiments of the invention can comprise a latch-type securing mechanism, preferably releasable, for securing the connection between lighting strips and connectors when installed but also allowing for convenient disengagement of the components for repairs.

The modular lighting strips of embodiments of the invention preferably comprise LED-type lighting strips described in Virginia Optoelectronics, Inc.'s U.S. Published Patent Application No. 2010/008090, entitled “Modular LED Lighting Systems and flexible or Rigid Strip Lighting Devices,” the disclosure of which is hereby incorporated by reference in its entirety.

The plug and socket components of the lighting systems can be oriented lengthwise in relation to the substrate strip and can have complementary shapes to provide for interconnection of a substrate strip with a connector. Embodiments also include plugs and plug holes that provide for co-planar, parallel, or perpendicular interconnection of the substrates, including any plug and plug hole orientation relative to the substrate. Further, for example, the lighting strips can be co-planar and be oriented in any direction relative to one another and/or relative to the connectors. In one embodiment, a lighting strip can be connected with a 4-way connector to continue the circuit of the lighting strip in three separate lighting strips, each of the three oriented in different directions, or each of the three in the same direction parallel to one another. Again, the shape and orientation of the junctions of the connector is typically dictated by a particular lighting system configuration that is desired. For example, if the connector provides for electrical contact from a single lighting strip or electrical source to three lighting strips arranged parallel to one another, the connector could be configured in the shape of a fork, where the input into the connector is represented by the fork handle and the three outputs are represented by the tines.

Also provided are connector assemblies for printed circuit boards (PCBs) comprising: a plug integrally formed at one end of a PCB; and a socket integrally formed at an opposing end of the PCB; wherein the plug and plug hole of the socket are oriented lengthwise in relation to the substrate strip and have complementary shapes to provide for removable, friction-fit, and latchless electrical interconnection of two or more substrates. Embodiments also include connector assemblies with plugs and plug holes that provide for co-planar, parallel, or perpendicular interconnection of the substrates, including any plug and plug hole orientation relative to the substrate. The connectors, whether integral with or not integral with the substrate, are typically of the male and corresponding or complementary female type, but can be of any known type of connector. It is especially preferred to have one female-type connector for one end of the lighting strip and a corresponding or complementary male-type connector for the opposing lengthwise end of the substrate.

More specifically, the connector assemblies can be configured to comprise a plug formed by electrical contacts mounted to an end of the PCB and operably connected to the PCB; and a socket mounted to an opposing end of the PCB which comprises a complementary plug hole with internal electrical contacts operably connected to the PCB. The connector can also comprise two plugs or two sockets in such an assembly.

Means for operably connecting a modular lighting strip to an electrical power supply can be provided by the plug or socket of the lighting strip, wire leads irremovably and operably connected to the lighting strip, or a non-conductive substrate strip comprising an electrical circuit and no light sources which is capable of operably connecting to a lighting strip by way of an integrally formed plug or socket. DC jack adapters can be used, and in the case of multi-color light displays for example the red, green, blue LED lighting strips can comprise an RGB-controller for controlling the timing, duration, and changes in color of the display.

The modular lighting systems can be constructed so that the first PCB is capable of being connected to a power supply by way of a plug, socket, or wire leads irremovably and operably connected to the first PCB.

The features of novelty and various other advantages that characterize the invention are pointed out with particularity in the claims forming a part hereof. However, for a better understanding of the invention, its advantages, and the objects obtained by its use, reference should be made to the drawings that form a further part hereof, and to the accompanying descriptive matter, in that there is illustrated and described a preferred embodiment of the invention. The features and advantages of the present invention will be apparent to those skilled in the art. While numerous changes may be made by those skilled in the art, such changes are within the spirit of the invention.

### BRIEF DESCRIPTION OF THE DRAWINGS

These drawings illustrate certain aspects of some of the embodiments of the present invention, and should not be used to limit or define the invention.

FIG. 1 is a photo illustrating a “cross” type, 4-way connector of the invention.

FIG. 2 is a photo illustrating a “double” type, 2-way connector for use in single color lighting systems of the invention.

FIG. 3 is a photo illustrating a “double” type, 2-way connector for use in RGB color lighting systems of the invention.

FIG. 4 is a photo illustrating a component used to join a single color lighting system to a power source.

FIG. 5 is a photo illustrating a component used to join a RGB lighting system to a power source.

FIGS. 6A-C are schematic diagrams depicting various views of an exemplary socket-type junction which can be used in the connectors of the invention.

FIGS. 7A-B are schematic diagrams depicting, respectively, a side elevation view and a top plan view of an exemplary plug-type junction, which can be used in the connectors of the invention.

FIGS. 8A-D and are schematic diagrams that depict various views of an exemplary socket-type end and complementary plug-type end of a multi-color flex strip, which can be used in the connectors of the invention.

FIGS. 9A-B are schematic diagrams depicting, respectively, a side elevation view and a top plan view of an exemplary plug-type end of a multi-color flex strip, which can be used as the plug portion of a connector.

FIGS. 10A-E are photos of various types of waterproof connectors and lighting strips that can be used according to the invention.

FIG. 11 is a photo of a connector of the invention operably connected with wire leads for transmitting electrical energy from a power source to, in, and through the connector assembly to a lighting strip with single-color LEDs.

FIG. 12 is a photo of a connector assembly according to the invention, which is a 4-way, cross-type connector comprising a rigid PCB supporting an electrical circuit which is in operable communication with four socket type junctions for interconnecting, both mechanically and electrically, up to four RGB type lighting strips to obtain a lighting system having light sources radiating away from the connector in four directions.

FIG. 13 is a photo of a connector assembly according to the invention, which is a 4-way, cross-type connector comprising a rigid PCB supporting an electrical circuit which is in operable communication with four socket type junctions for interconnecting, both mechanically and electrically, up to four single-color type lighting strips to obtain a lighting system having light sources radiating away from the connector in four directions.

FIG. 14 is a photo of a connector of the invention operably connected with wire leads for transmitting electrical energy from a power source to, in, and through the connector assembly to an RGB-type lighting strip with LEDs.

FIG. 15 is a photo of a connector assembly according to the invention, which is a 2-way, “double” connector comprising two socket type junctions for interconnecting, both mechanically and electrically, up to two single-color type lighting strips to increase the overall length of a lighting system.

FIG. 16 is a photo of a connector assembly according to the invention, which is a 2-way, “double” connector comprising two socket type junctions for interconnecting, both mechanically and electrically, up to two RGB-type lighting strips to increase the overall length of a lighting system.

### DETAILED DESCRIPTION OF PREFERRED EMBODIMENTS

In accordance with embodiments of the present invention, provided are various connector assemblies for lighting strips and lighting strip systems with connector assemblies. More particularly, the present invention relates to modular lighting systems, which provide for mechanical (e.g., physical) and electrical interconnection of multiple lighting strip devices to form lighting systems.

One of the many potential advantages of the connectors of the present invention, only some of which are discussed herein, is that the connectors may be used with a variety of lighting strips that can be combined and conveniently interconnected with the strip lighting to form modular lighting systems. In some embodiments, the connectors may be used with rigid lighting strips, flexible lighting strips, water-resistant, waterproof, or non-waterproof, and any combination thereof.

In certain embodiments, the connectors may also be used with PCBs that can be combined and conveniently interconnected with at least one operably mounted LED to form modular lighting systems. One of the advantages of the connectors of the present invention may include a multitude of configurations wherein they may provide for easily removable, friction-fit, latchless, and electrical interconnection of two or more components. Another advantage includes that certain embodiments of the invention may include lighting systems comprising a latch-type securing mechanism, preferably releasable, capable of securing the connection between lighting strips and connectors when installed but also allowing for convenient disengagement of the components for repairs. This should reduce the cost of making and disassembling such lighting systems, especially when components can be reused or are not damaged by previous installation means.

In embodiments of lighting systems according to the invention, included is a modular lighting system comprising: 1) a plurality of modular lighting strips each comprising: a non-conductive substrate strip comprising an electrical circuit; a plurality of light sources operably connected to the electrical circuit; a plug integrally formed at an end of the substrate strip; and a socket integrally formed at an opposing end of the substrate strip; wherein the plug and socket provide for removable, friction-fit, and electrical interconnection of two or more circuits; 2) a connector assembly comprising: a non-conductive substrate with an electrical circuit; two or more plugs and/or sockets integrally-formed with the substrate and in operable communication with the electrical circuit, wherein the plugs and sockets provide for removable, friction-fit, and electrical interconnection of two or more circuits of lighting strips when connected therewith; and 3) means for operably connecting a modular lighting strip or the connector to an electrical power supply for providing power to the light sources. Such connectors can also be used as connectors and provided as components to a lighting system.

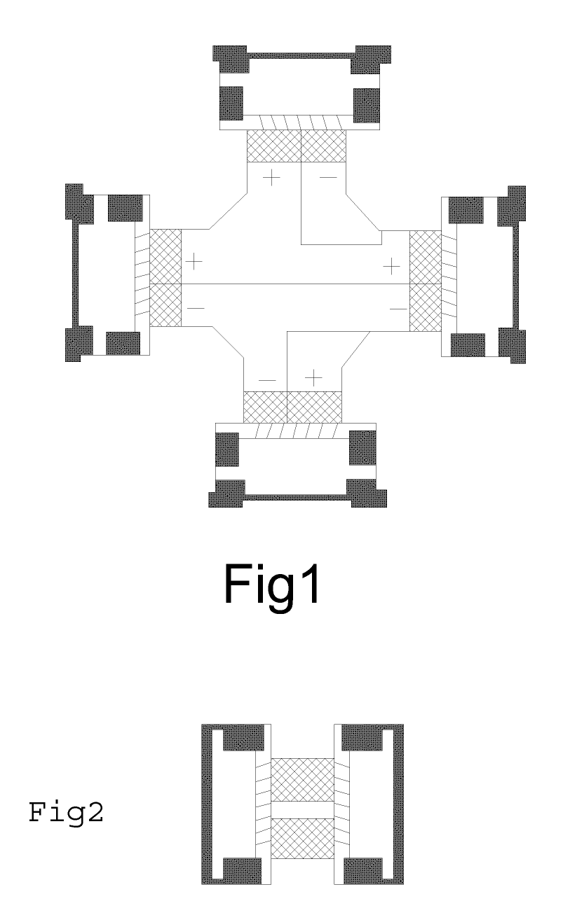

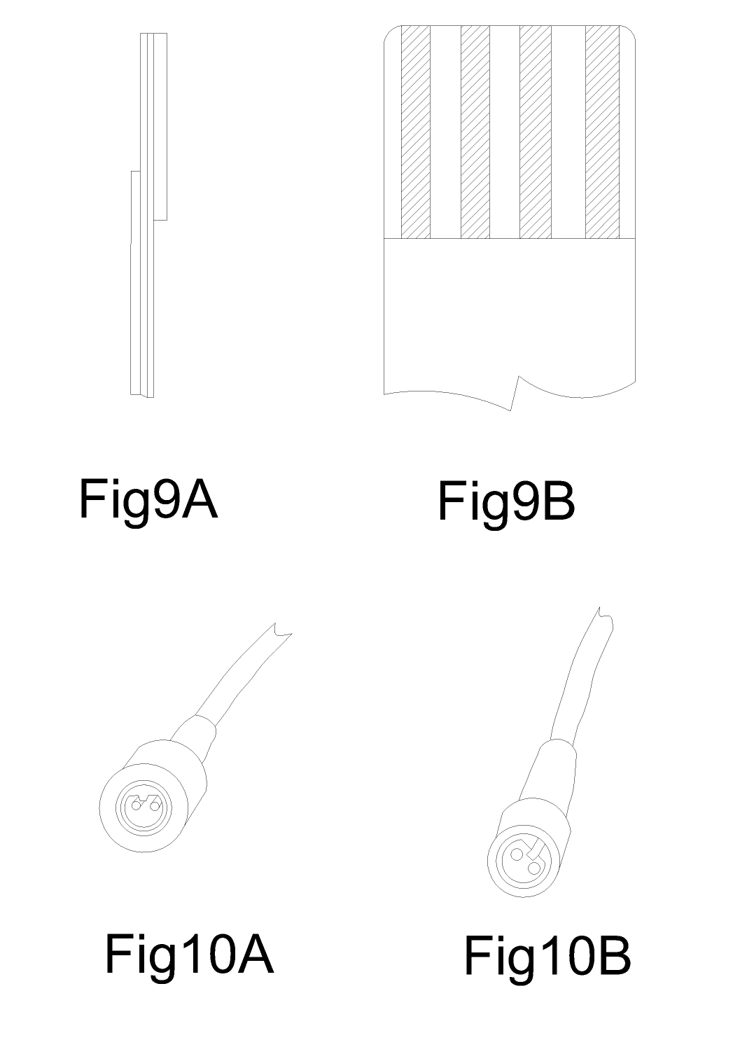

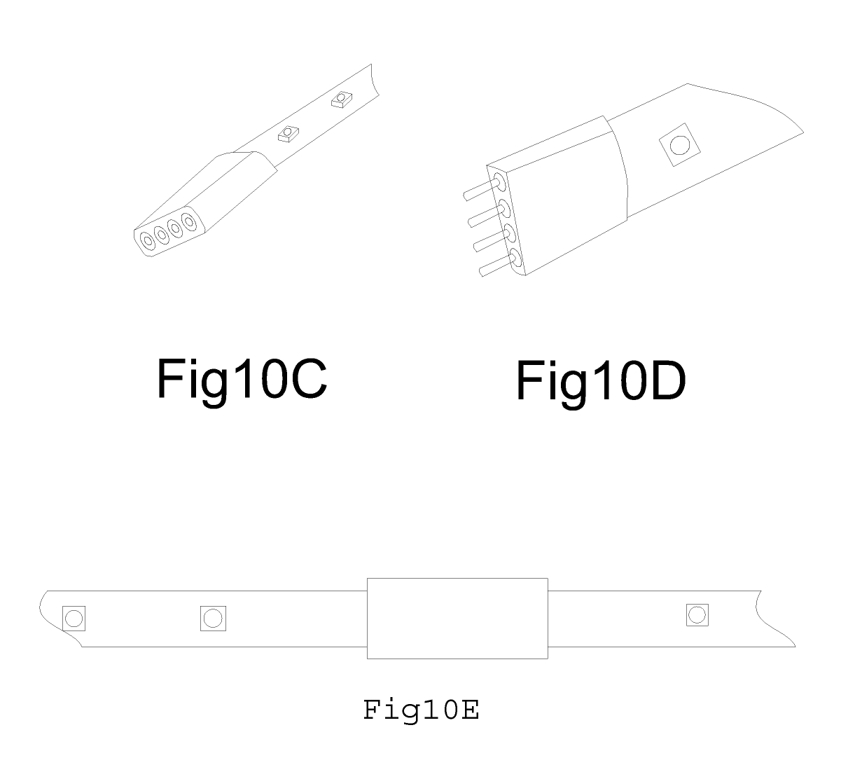

Referring now to the Figures, FIG. 1 shows a 4-way connector of the invention. As shown, four socket-type components are integrally formed with a non-conductive PCB substrate comprising an electrical circuit. Each of the sockets is joined with the PCB in a manner to provide for an operable electrical circuit through each socket whether into or out of the electrical circuit of the PCB. Further, each socket is operably configured to provide for removable, friction-fit, and electrical interconnection of two or more circuits, whether secured with a latching mechanism (with or without friction fit of the socket with a plug) or not to join together two circuits. Although sockets are shown in this embodiment, one or more or all of the sockets can be replaced by plug-type components. More particularly, the 4-way connector can comprise one socket and three plugs, two sockets and two plugs, three sockets and one plug, or four sockets, or four plugs. The 4-way connector can also be constructed in a manner to provide for a waterproof connection with the connector, for example, using the techniques demonstrated in FIGS. 10A-E.

In a strip lighting system, power would travel from a power source through one or more lighting strips comprising light sources, such as LEDs. Preferably the lighting strips are operably configured to be joined together in a releasable manner to provide a continuous electrical circuit. When it is desired to have the light sources continue on additional paths, or when the length of the overall lighting system needs to be increased by joining into the system an additional lighting strip, a connector would be introduced to the lighting system.

For example, using a 4-way connector, a single lighting strip could provide a circuit for the energy from the power source to enter the connector. Having a connector operably configured to allow the flow of electricity into the connector at one of the sockets/plugs and out of the connector at three sockets/plugs, the energy could pass through the connector from the single input lighting strip or power source and exit the connector at three additional lighting strips. The electrical circuit of the connectors can be configured in any manner to provide for as many inputs and/or outputs as is needed to provide the desired lighting effect or pathway(s) of lighting strips. Not all of the junctions of a connector must be used if the connector is installed. For example, if a 90 degree turn is needed in the lighting system, a 4-way connector can be introduced and only two of the plugs or sockets used. The unused junctions can be left alone or capped.

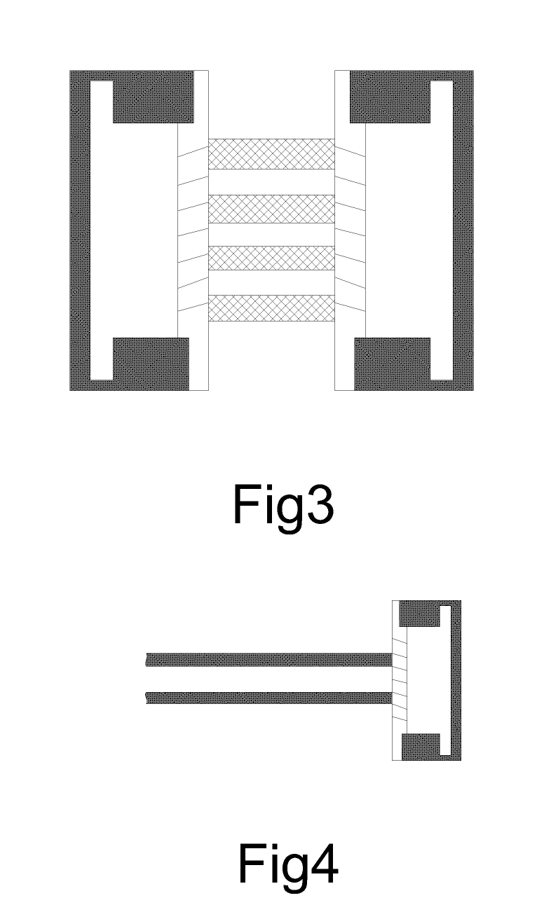

As shown in FIG. 2, a 2-way “double” connector for single color lighting systems can comprise one or more sockets/plugs joined together. The sockets/plugs are integrally formed into the connector to provide for an electrical pathway through the connector from one socket/plug to the other. As shown, the socket/plugs can be joined by way of soldering the electrical circuits together. Here, opposing ends of the double connector are two sockets, but could equally be two plugs, or a plug and a socket. A resin or silicone gel can be used to cover the PCB and the electrical connection between the PCB and the connector to render the unit waterproof or water resistant, or the connector can be encased in a plastic or rubber (insulative) sleeve. Any of the components, lighting strips, connectors, etc., described in this application can be rendered waterproof, or water-resistant in this manner.

FIG. 3 shows a 2-way “double” connector of the invention for RGB lighting systems. The sockets/plugs are integrally formed into the connector to provide for an electrical pathway through the connector from one socket/plug to the other. As shown, the socket/plugs can be joined by way of soldering the electrical circuits together. Here, opposing ends of the double connector are two sockets, but could equally be two plugs, or a plug and a socket. The electrical connections of this type of connector can also be protected from the elements with any number of available waterproofing or water-resistance means.

FIG. 4 shows a component that may be used to join single color lighting system to a power source. FIG. 5 shows a component that may be used to join RGB lighting system to a power source. Such components of the systems typically provide for electrical and mechanical connection between a power source and the lighting system without providing light sources. However, a lighting strip and/or a connector could also be adapted for direct connection with a power source, for example, by configuring one end of the lighting strip or connector for plugging directly into a wall outlet.

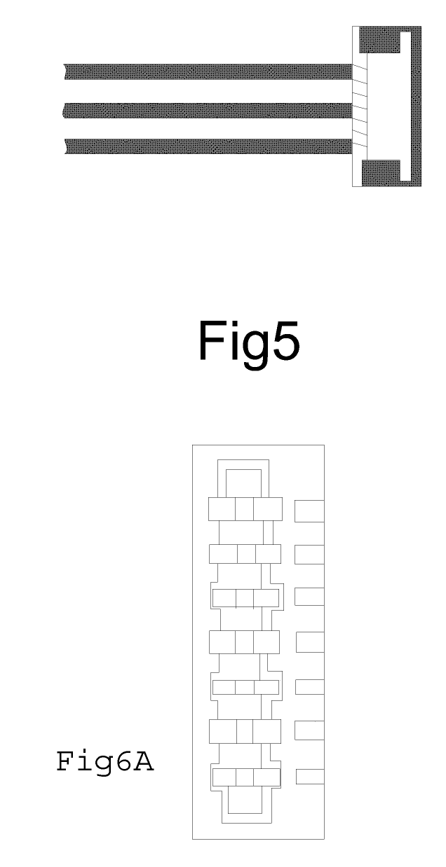

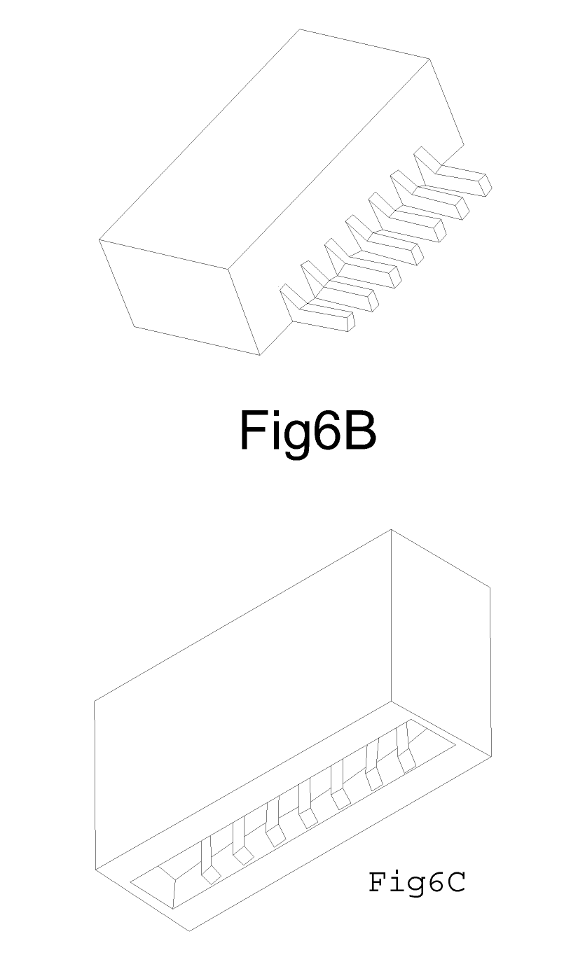

FIGS. 6A-C (also numbered respectively as 7D-F) show various views of an exemplary socket-type junction which can be used in the connectors and lighting strips of the invention. In particular, the socket shown is compatible with single color flexible lighting strips. This socket type can be incorporated into any of the 2-way, 3-way, or 4-way, etc., connectors. Further, the socket can be made waterproof, if desired.

In FIG. 6A, a front elevation view of socket is provided, which provides a detailed view of plug hole. The plug hole comprises electrical contacts within the hole. Each electrical contact corresponds in size, shape, length, and number with a wire leads incorporated as part of the socket. Preferably, the wire leads are irremovably connected to the contacts. Both the wire leads and contacts are spaced and sized to accommodate connection with one another and provide for an electrical path from the circuit of one PCB (lighting strip) to the circuit of another during use. If desired, the connectors can also be joined together in a system, where needed and it is not required to alternate between connector and lighting strip. This is true for any embodiment provided in this application.

A rear perspective view of socket, FIG. 6B, shows wire leads extending externally from socket. Wire leads are configured to be joined with the circuit portion of the connector in a manner to allow a flow of current to pass from a lighting strip, through the circuitry of the connector, and in and through the socket to another lighting strip or connector. A front perspective view of a socket embodiment, FIG. 6C, shows plug hole, electrical contacts, and wire leads in relation to one another. In preferred embodiments, the socket-type portion of the connector is the same as the socket-type portion of the lighting strips joined with the connector and is compatible with the plug-type portion of the lighting strips. That is, in embodiments the plug and socket ends of the lighting strips allow for mating of the lighting strips with the connectors by way of mating plugs and sockets of each.

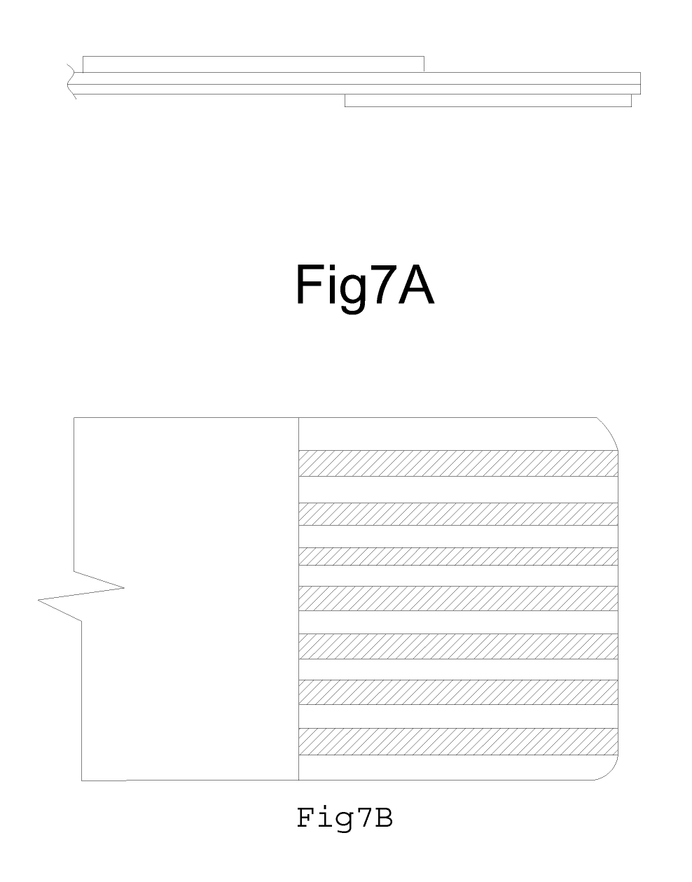

FIGS. 7A-B show, respectively, a side elevation view and a top plan view of an exemplary plug-type junction, which can be used in the connectors of the invention. This type of plug can be incorporated into any of the 2-way, 3-way, or 4-way, etc., connectors and made waterproof if desired. The plug shown is compatible with single color flexible lighting strips.

FIGS. 7A-B show, respectively, a side elevation view and a top plan view of an exemplary plug-type end of a single color flex strip, which corresponds to the plug-type portion of the connector. In this embodiment, the plug comprises electrical contacts. Electrical contacts can be arranged in or on the lighting strip and in or on the circuit of the connector in any manner, so long as they provide for electrical and physical connection with another connector, lighting strip, or power source. As shown in this embodiment, 7 electrical contacts are arranged lengthwise to the substrate and parallel to one another with some spacing between them. A corresponding socket would be arranged in a similar fashion.

The contacts can be connected, preferably irremovably mounted, to the substrate (of the lighting strip and connector) in a manner that provides for physical and electrical connection of the contacts to the electrical circuit (not shown) of the substrate. As in FIG. 7A, the plug can overlap with substrates lightly to provide for the connection by way of contacting the contacts with appropriate parts of the PCB circuit (of the lighting strip and connector). The material of the plug is advantageously also plastic, however, typically a more rigid material than substrate. As shown, several layers of the same or different material may be used to increase the strength of the strip (or connector) at plug. A more rigid plug will provide for ease of connection with a corresponding socket during use, as guiding and inserting the plug into the socket will be easier with a more rigid material. The plug has a size and shape that complement the size and shape of a corresponding socket. The complementary size and shape allow for a friction fit, releasable, and latchless engagement between a socket and plug, for example, the socket and plug of FIGS. 6A-7B.

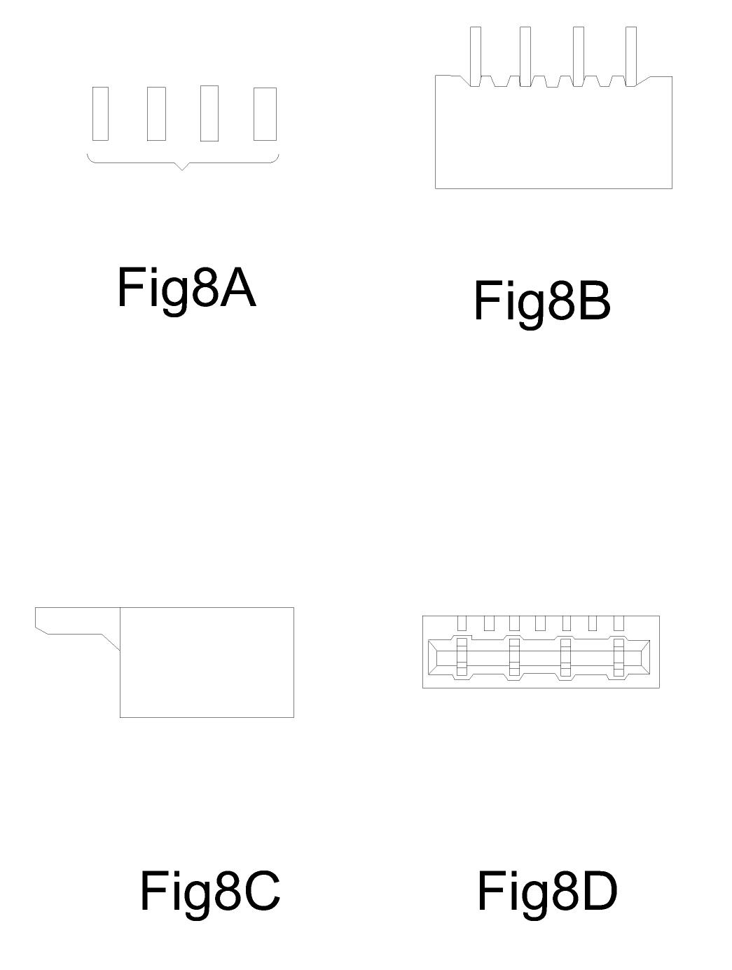

FIGS. 8A-D and 9A-B show various views of an exemplary socket-type end and complementary plug-type end of a multi-color flex strip, which can be used in the connectors of the invention. These socket and plug types can be incorporated into any of the 2-way, 3-way, or 4-way, etc., connectors. Further, the socket can be made waterproof, if desired.

In particular, FIG. 8A shows a top plan view of a representative formation of electrical contacts that could be installed in or on a substrate (lighting strip or connector) at the socket end. As shown, multiple contacts are provided, e.g., 4, but any number can be used depending on the type of light sources used. Each electrical contact corresponds in size, shape, length, and number with a wire lead incorporated as part of the socket. A bottom plan view of the socket, FIG. 8B, shows wire leads extending externally from the socket. Further, FIG. 8C shows another view of the socket, a side elevation view, highlighting the wire leads, which are preferably irremovably connected to the contacts. Both the wire leads and contacts are spaced and sized to accommodate connection with one another and provide for an electrical path from the circuit of one PCB to the circuit of another during use. In FIG. 8D, a front elevation view of socket is provided, which provides a more detailed view of plug hole. The plug hole comprises electrical contacts within the hole, which correspond to the number of contacts and wire leads.

FIGS. 9A-B show, respectively, a side elevation view and a top plan view of an exemplary plug-type end of a multi-color flex strip, which can be used as the plug portion of a connector. In this embodiment, the plug comprises electrical contacts. Electrical contacts can be arranged in or on the substrate (lighting strip or connector) in any manner. As shown in this embodiment, 4 electrical contacts are arranged lengthwise to substrate and parallel to one another with some spacing between them. The contacts can be connected, preferably irremovably mounted, to the substrate in a manner that provides for physical and electrical connection of the contacts to the electrical circuit (not shown) of the substrate. As shown in FIG. 9A, the plug can overlap with the substrate slightly to provide for the connection by way of contacting the contacts with appropriate parts of the PCB circuit. The material of the plug is advantageously also plastic, typically a more rigid material than substrate or several layers of the same material. A more rigid plug will provide for ease of connection with a corresponding socket during use, as guiding and inserting the plug end into the socket will be easier with a more rigid material. The plug has a size and shape that complement the size and shape of a corresponding socket. The complementary size and shape allow for a friction fit, releasable, and latchless engagement between a socket and plug, e.g., the socket and plug of FIGS. 8A-9B.

FIGS. 10A-E are photos of various types of waterproof connectors for lighting systems of the invention. FIGS. 10A-B show a waterproof or water-resistant version of connectors according to the invention. More specifically, as shown in FIGS. 10A-B, the plug/socket connection can be performed in part by a friction fit between the corresponding electrical components of the plug and corresponding socket and/or by a screw-type connection. Even further, the connection between the plug and socket can be configured to be a latchless type connection, where the components are held together by insertion of the male electrical components into the corresponding female components, or an additional latch can be included to secure the mating ends together. A protective sleeve can also be installed over the connection between two strips alone or in combination with additional waterproofing material, such as silicone gel to fill in any gaps. FIGS. 10C-D show another waterproof or water-resistant version of the lighting strips, wherein a silicone gel covers the surface of the PCB and the LEDs and the connector ends are encompassed with a protective cover or sleeve. When the lighting strips are joined together, a waterproof or water-resistant connection is made. Any of the multi-way connectors of the invention can be configured in this manner to provide a waterproof or water-resistant connector by encasing the connector or the PCB with silicone gel or a resin and/or encasing or covering portions of the connector (except for the mating faces) to provide a water-resistant or waterproof seal once connected with lighting strips.

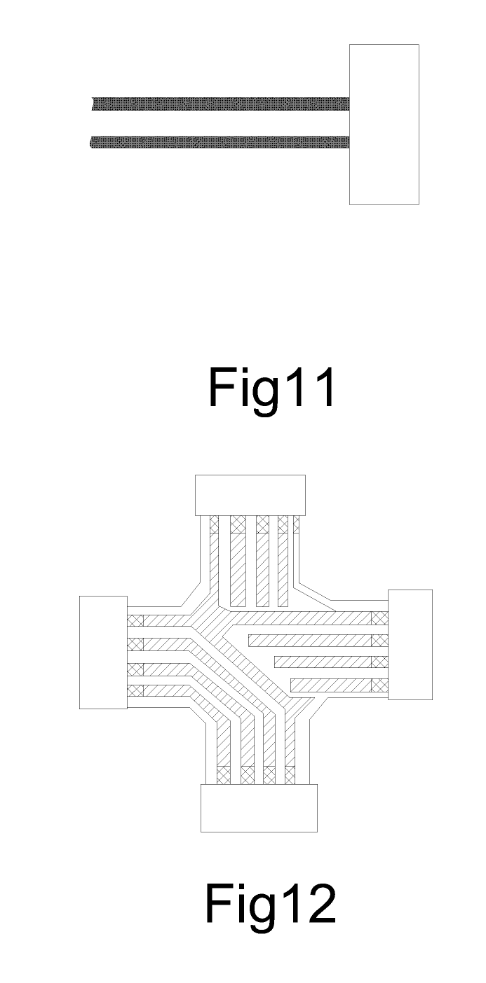

FIG. 11 is a photo of a connector of the invention operably connected with wire leads for transmitting electrical energy from a power source to, in, and through the connector assembly to a lighting strip with single-color LEDs. As with any of the connectors, lighting strips, lighting systems, or any component of a lighting system described in this application, the connectors and/or PCBs can be provided in any color. In this manner the lighting systems can be installed, for example, over a similar or same color background (e.g., white wall and white PCB and connectors) to camouflage the existence of the lighting system once installed.

FIG. 12 is a photo of a connector assembly according to the invention, which is a 4-way, cross-type connector comprising a rigid PCB supporting an electrical circuit which is in operable communication with four socket type junctions for interconnecting, both mechanically and electrically, up to four RGB type lighting strips to obtain a lighting system having light sources radiating away from the connector in four directions. Here, the connector is configured to accept electrical energy from a power source or a lighting strip into one of the sockets and deliver the electrical energy through the electrical circuit on or in the PCB to the three other sockets and into three other lighting strips. In this manner, the lighting system can be more complex than a straight line. A lighting system with this type of connector can for example provide lighting along two seemingly intersecting lines. The connectors and PCB can be provided in any color, for example, to match the color of a corresponding installation surface to which the lighting system will be installed. Additionally, the PCB and/or connectors can be made waterproof or water-resistant by covering with a waterproof material, silicone gel, resin, plastic, rubber, or any insulative sleeve.

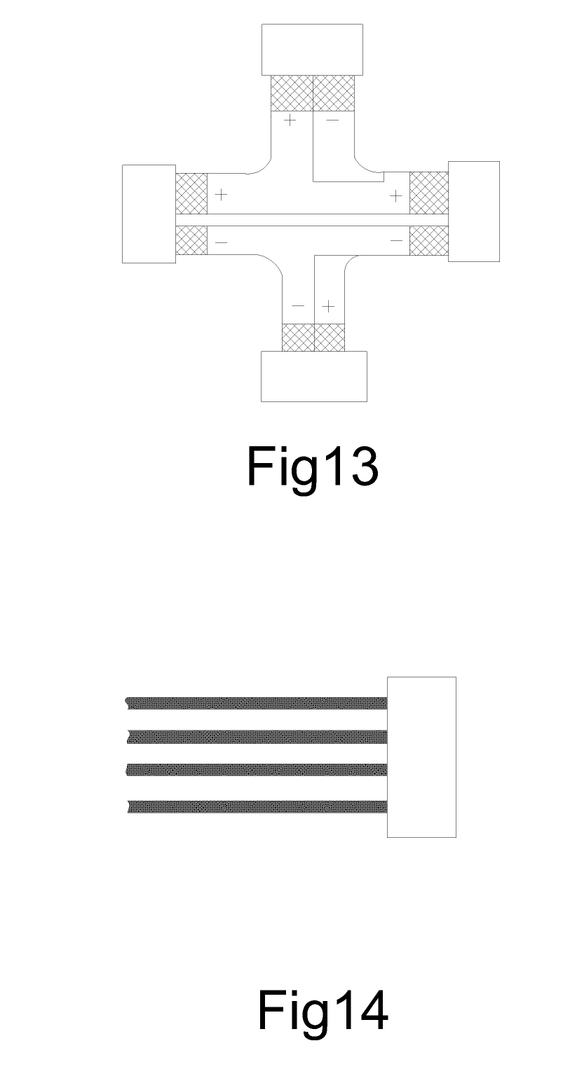

FIG. 13 is a photo of a connector assembly according to the invention, which is a 4-way, cross-type connector comprising a rigid PCB supporting an electrical circuit which is in operable communication with four socket type junctions for interconnecting, both mechanically and electrically, up to four single-color type lighting strips to obtain a lighting system having light sources radiating away from the connector in four directions. This connector has the same capabilities as the RGB-type connector described in FIG. 12, such as being able to configure more complex lighting displays, providing the lighting system in a color for camouflaging the system when installed, and/or waterproofing the lighting system as described above.

FIG. 14 is a photo of a connector of the invention operably connected with wire leads for transmitting electrical energy from a power source to, in, and through the connector assembly to an RGB-type lighting strip with LEDs. As with any of the connectors, lighting strips, lighting systems, or any component of a lighting system described in this application, the connectors and/or PCBs of FIG. 14 can be provided in any color. In this manner the lighting systems can be installed, for example, over a similar or same color background (e.g., white wall and white PCB and connectors) to camouflage the existence of the lighting system once installed. The connectors can also comprise waterproofing or insulating materials.

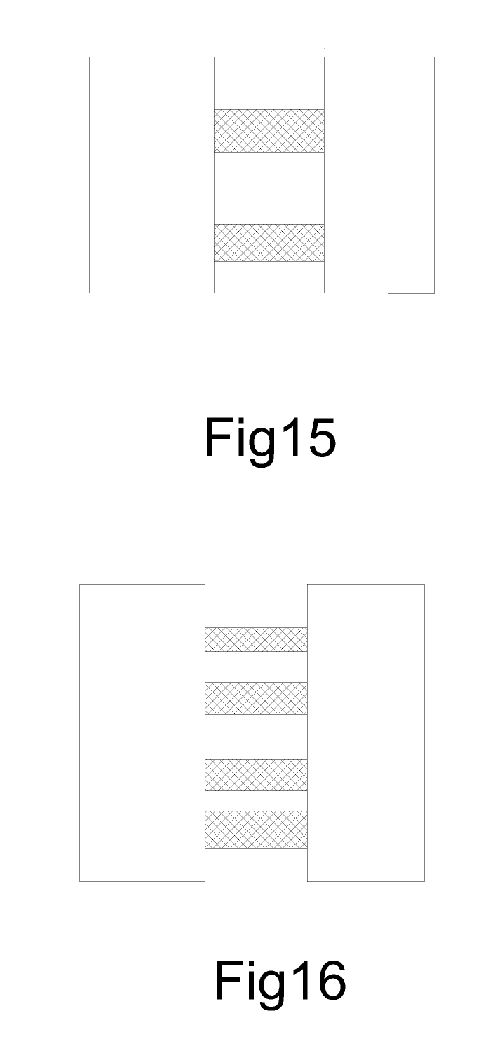

FIG. 15 is a photo of a connector assembly according to the invention, which is a 2-way, “double” connector comprising two socket type junctions for interconnecting, both mechanically and electrically, up to two single-color type lighting strips to increase the overall length of a lighting system. The 2-way connector in this embodiment comprises two identical sockets soldered together at their external electrical contacts. Using existing universal sockets as shown in FIG. 15, provides for quick and simple manufacturing of the connectors, as no special connector configuration is needed, i.e., no additional parts are needed for the lighting system, when the connectors can comprise the same components found in lighting strips. Further, if desired, the connectors can be made on site during installation of the lighting system by joining them as shown with solder. The connectors, or any connector described in this application can also comprise two different sockets, or one socket and one plug, or any combination of junctions to meet particular needs of a desired lighting system.

FIG. 16 is a photo of a connector assembly according to the invention, which is a 2-way, “double” connector comprising two socket type junctions for interconnecting, both mechanically and electrically, up to two RGB-type lighting strips to increase the overall length of a lighting system. The connector of FIG. 16 is similar to that shown in FIG. 15 and thus has all of the same capabilities, including the advantage of using existing lighting system components. Any of these connectors can also be made for waterproof lighting systems. The 2-way, similar to the multi-way designs, can alternatively comprise an intermediate PCB to join the sockets. Such connectors also present ease of manufacture by requiring only connection with the PCB instead of a completely discrete component. For example, existing sockets can be soldered to opposing ends of a PCB comprising a desired electrical circuit, wherein the external electrical contacts of the sockets are placed in contact with appropriate portions of the electrical circuit of the PCB and then soldered or otherwise connected therewith in a manner to enable an electrical current to travel through one socket through the PCB to the other socket.

FIGS. 14A-H show a method for waterproofing according to an embodiment of the invention. In particular, as shown silicone gel (or other waterproofing material) can be used to connect a plastic sleeve to a terminal end of a flexible lighting strip of the invention. Such a sleeve could also be used over and encompassing two ends of lighting strips to be joined together by electrical connectors to ensure the waterproof connection.

The lighting devices of the present invention can be dimmable and/or programmable so as to provide color mixing, a chasing circuit, flashing, etc. Further, the light strips can operate at voltages of 12 or 24 VDC. To keep the electrical current consistent during operation, integrated circuits, transistors, and/or resistors can be used.

Specific embodiments include: Embodiment 1. A connector assembly for modular lighting strips comprising: two or more female-type socket components each comprising a separate housing encompassing internal electrical contacts disposed within a hole and operably connected with external electrical contacts or disposed as external electrical contacts from the housing; wherein corresponding exterior electrical contacts of the sockets are operably connected with one another or are operably connected with an electrical circuit of a printed circuit board (PCB), such that during operation in a lighting system power flows through one socket to another socket or through one socket, the PCB and another socket; and wherein the sockets provide for removable, friction-fit, and electrical interconnection of lighting strips when connected therewith. The connector assembly of Embodiment 1 which comprises a 3- or 4-way connector. The connector assembly of Embodiment 2 comprising one socket for accepting electrical energy, remaining sockets or plugs for outputting the energy into one or more lighting strip, and an electrical circuit for delivering the energy to the remaining sockets or plugs. The connector assembly of Embodiment 1, wherein the connector is selected from the group consisting of a y-type connector, a cross-type connector, a double connector, and any combination thereof. The connector assembly of Embodiment 2, which is waterproof. The connector assembly of Embodiment 1, wherein the connector assembly further comprises a latch-type securing mechanism for securing the connection between lighting strips and the connector. The connector assembly of Embodiment 6, wherein the latch-type securing mechanism is releasable. The connector assembly of Embodiment 1, wherein the PCB is rigid. The connector assembly of Embodiment 1, wherein the lighting strips comprise LEDs. A modular lighting system comprising: 1) a plurality of modular lighting strips each comprising: a non-conductive substrate strip comprising an electrical circuit; a plurality of light sources operably connected to the electrical circuit; a plug operably connected to one end of the substrate strip; and a socket operably connected at an opposing end of the substrate strip; wherein the plug and socket provide for removable, friction-fit, and electrical interconnection of two or more circuits; a connector assembly comprising: two or more female-type socket components each comprising a housing encompassing internal electrical contacts disposed within a hole and operably connected with external electrical contacts or disposed as external electrical contacts from the housing; wherein corresponding exterior electrical contacts of the sockets are operably connected with one another or are operably connected with an electrical circuit of a printed circuit board (PCB), such that during operation in a lighting system power flows through one socket to another socket or through one socket, the PCB and another socket; and wherein the sockets of the connector are the same type of components as the sockets of the lighting strips; and means for operably connecting a modular lighting strip or the connector to an electrical power supply for providing power to the light sources. The modular lighting system of Embodiment 10 wherein the connector comprises a 3- or 4-way connection. The modular lighting system of Embodiment 11 comprising one socket for accepting electrical energy, remaining sockets or plugs for outputting the energy into one or more lighting strip, and an electrical circuit for delivering the energy to the remaining sockets or plugs. The modular lighting system of Embodiment 11 wherein the connector further comprises a releasable latch-type securing mechanism for securing the connection between the lighting strips and the connectors. The modular lighting system of Embodiment 11 wherein the socket or socket components of the lighting strips are the same as the socket components of the connector or connectors. The modular lighting system of Embodiment 10 wherein at least one of the lighting strips comprises no LEDs. The modular lighting system of Embodiment 10 wherein at least one of the lighting strips comprises LEDs. The modular lighting system of Embodiment 10 wherein the connector provides for co-planar, parallel, or perpendicular interconnection of the lighting strips. A modular lighting system comprising: at least one first printed circuit board (PCB), optionally comprising at least one operably mounted light emitting diode (LED), wherein the first PCB is capable of being operably connected to a power supply and to a second PCB; at least one second PCB with at least one operably mounted LED, which is capable of being operably connected to the first PCB and optionally operably connected to a third PCB; and at least one connector comprising multiple sockets and plugs for operably connecting two or more consecutive PCBs. The modular lighting system of Embodiment 18 wherein the connector is operably configured to provide a multi-way connection of the lighting strips. The modular lighting system of Embodiment 18 wherein the connector further comprises a latch-type securing mechanism for securing the connection between the lighting strips and the connectors.

The lighting systems and strip lighting devices of the present invention are useful in many applications where strip-type lighting can be used. For example, the lighting devices and systems according to the invention can be used in any residential or commercial application where such lighting is desired for decoration, backlighting or functional lighting, including for aisle, path, and contour lighting, such as in theatres, hospitals, airplanes, concert halls, stadiums, and auditoriums; elegant interior decoration, such as in restaurants, nightclubs, casinos, piers, malls, streets, stations, stages, offices and lobbies; homes, including as accent lighting in living rooms, under cabinet lighting in kitchens, backlighting in display cases and shelving systems, functional and decorative lighting in entryways and recreational rooms; seasonal applications, such as for holiday decorations or landscape lighting; automobiles; architectural lighting, even including tent or canopy lighting; signal lighting; and backlighting larger size signs. The applications mentioned are merely representative of the numerous applications for which the lighting systems and strip lighting devices of the present invention may be applicable.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. It is intended that the specification and examples be considered as exemplary in nature and that variations that do not depart from the essence of the invention are intended to be within the scope of the invention.

1. A connector assembly for modular lighting strips comprising:
two or more female-type socket components each comprising a separate housing encompassing internal electrical contacts disposed within a hole and operably connected with external electrical contacts or disposed as external electrical contacts from the housing;
wherein corresponding exterior electrical contacts of the sockets are operably connected with one another or are operably connected with an electrical circuit of a printed circuit board (PCB), such that during operation in a lighting system power flows through one socket to another socket or through one socket, the PCB and another socket; and
wherein the sockets provide for removable, friction-fit, and electrical interconnection of lighting strips when connected therewith.

2. The connector assembly of claim 1 which comprises a 3- or 4-way connector.

3. The connector assembly of claim 2 comprising one socket for accepting electrical energy, remaining sockets or plugs for outputting the energy into one or more lighting strip, and an electrical circuit for delivering the energy to the remaining sockets or plugs.

4. The connector assembly of claim 1, wherein the connector is selected from the group consisting of a y-type connector, a cross-type connector, a double connector, and any combination thereof.

5. The connector assembly of claim 2, which is waterproof.

6. The connector assembly of claim 1, wherein the connector assembly further comprises a latch-type securing mechanism for securing the connection between lighting strips and the connector.

7. The connector assembly of claim 6, wherein the latch-type securing mechanism is releasable.

8. The connector assembly of claim 1, wherein the PCB is rigid.

9. The connector assembly of claim 1, wherein the lighting strips comprise LEDs.

10. A modular lighting system comprising:
1) a plurality of modular lighting strips each comprising:
a non-conductive substrate strip comprising an electrical circuit;
a plurality of light sources operably connected to the electrical circuit;
a plug operably connected to one end of the substrate strip; and
a socket operably connected at an opposing end of the substrate strip;
wherein the plug and socket provide for removable, friction-fit, and electrical interconnection of two or more circuits;
2) a connector assembly comprising:
two or more female-type socket components each comprising a housing encompassing internal electrical contacts disposed within a hole and operably connected with external electrical contacts or disposed as external electrical contacts from the housing;
wherein corresponding exterior electrical contacts of the sockets are operably connected with one another or are operably connected with an electrical circuit of a printed circuit board (PCB), such that during operation in a lighting system power flows through one socket to another socket or through one socket, the PCB and another socket; and
wherein the sockets of the connector are the same type of components as the sockets of the lighting strips; and
3) means for operably connecting a modular lighting strip or the connector to an electrical power supply for providing power to the light sources.

11. The modular lighting system of claim 10 wherein the connector comprises a 3- or 4-way connection.

12. The modular lighting system of claim 11 comprising one socket for accepting electrical energy, remaining sockets or plugs for outputting the energy into one or more lighting strip, and an electrical circuit for delivering the energy to the remaining sockets or plugs.

13. The modular lighting system of claim 11 wherein the connector further comprises a releasable latch-type securing mechanism for securing the connection between the lighting strips and the connectors.

14. The modular lighting system of claim 11 wherein the socket or socket components of the lighting strips are the same as the socket components of the connector or connectors.

15. The modular lighting system of claim 10 wherein at least one of the lighting strips comprises no LEDs.

16. The modular lighting system of claim 10 wherein at least one of the lighting strips comprises LEDs.

17. The modular lighting system of claim 10 wherein the connector provides for co-planar, parallel, or perpendicular interconnection of the lighting strips.

18. A modular lighting system comprising:
at least one first printed circuit board (PCB), optionally comprising at least one operably mounted light emitting diode (LED), wherein the first PCB is capable of being operably connected to a power supply and to a second PCB;
at least one second PCB with at least one operably mounted LED, which is capable of being operably connected to the first PCB and optionally operably connected to a third PCB; and
at least one connector comprising multiple sockets and plugs for operably connecting two or more consecutive PCBs.

19. The modular lighting system of claim 18 wherein the connector is operably configured to provide a multi-way connection of the lighting strips.

20. The modular lighting system of claim 18 wherein the connector further comprises a latch-type securing mechanism for securing the connection between the lighting strips and the connectors.
